(19) United States
(12) Patent Application Publication
(10) Pub. No.: US 2010/0104880 A1
(43) Pub. Date: Apr. 29, 2010

(54) BIOCOMPATIBLE POLYMERS POLYMER, TIE-COATS-, METHODS OF MAKING AND USING THE SAME, AND PRODUCTS INCORPORATING THE POLYMERS

(75) Inventor: Harold E. Garey, Methuen, MA (US)

Correspondence Address: MILLS & ONELLO LLP, ELEVEN BEACON STREET, SUITE 605, BOSTON, MA, 02108, US

(73) Assignee: CORNOVA, INC., Burlington, MA (US)

(21) Appl. No.: 12/526,874

(22) PCT Filed: Feb. 13, 2008
(86) PCT No.: PCT/US08/53837

§ 371 Date: Aug. 12, 2009

Related U.S. Application Data
(60) Provisional application No. 60/889,655, filed on Feb. 13, 2007.

(51) Int. Cl. C08G 18/00; B32B 15/095

(52) U.S. Cl. 428/457; 528/44; 525/452

(57) ABSTRACT

Biodurable, biocompatible polymers for coating applications and tie-coat polymers especially useful in tie-coat applications as an intermediate layer between two other layers or coatings or between a surface and a coating applied to that surface are disclosed, together with methods for preparing such biocompatible polymers and tie-coat polymers, methods for using such biocompatible polymers and tie-coat polymers, and products that use or incorporate such biocompatible polymers and tie-coat polymers. The biocompatible polymers generally comprise polyurethane polymers having polycarbonate backbones, and the tie-coat polymers useful with these biocompatible polymers generally comprise polyurea or polyurethane-polyurea polymers.

### FIELD OF THE INVENTION

The present invention relates generally to biodurable, biocompatible polymers, to polymers that are especially useful in tie-coat applications (that is, as an intermediate layer between two other layers or coatings or between a surface and a coating applied to that surface), to methods for preparing such biocompatible and tie-coat polymers, to methods for using such biocompatible and tie-coat polymers, and to products that use or incorporate such biocompatible and tie-coat polymers. The biocompatible polymers of this invention generally comprise polyurethane polymers having polycarbonate backbones, and the tie-coat polymers useful with these biocompatible polymers generally comprise polyurea or polyurethane-polyurea polymers.

### BACKGROUND OF THE INVENTION

It is known in the art to prepare medical devices for internal body applications comprised in whole or at least in part of biocompatible materials. Such biocompatible materials are typically polymers. For some application, it may be possible to fashion the entire medical device from biocompatible material. Commonly, however, the biocompatible materials by themselves, lack the strength, rigidity, stress/strain resistance, or other physical properties demanded for a particular internal body application. For example, medical stents are typically small metal scaffolds used to mechanically hold open and support constricted coronary arteries. Medical stents intended for such cardiovascular applications typically cannot be successfully fashioned completely from biocompatible materials.

For more physically demanding applications, such as in medical device applications, one approach is to fashion the device from a physically stronger and structurally more durable material, such as a metal or metal alloy, and then to coat the exposed surfaces of such articles or structures with one or more layers or coatings to obtain certain desirable properties, such as biocompatibility, for the completed device. Thus, it is known in the art to apply coatings to medical devices designed for internal body uses to provide various special properties. For example, U.S. Pat. Publication US 2002/0138130, which is incorporated herein by reference, teaches applying a radiopaque layer to intravascular devices for visualization purposes. A capping layer is then applied on the radiopaque layer to prevent exposure of the radiopaque material to surrounding tissues. A method of coating the device is also described.

U.S. Pat. No. 5,001,208, which is also incorporated herein by reference, teaches preparing a particular type of linear polyurethane elastomers based on combining a polycarbonate polyol, a polyether polyol, at least two extenders, and a solid diisocyanate compound. In a preferred preparation mode for these particular elastomers, the diisocyanate compound is modified by reaction with one of the extenders to form a modified diisocyanate component which is a liquid at room temperature prior to reaction with the polyols and other extender. The elastomers of this particular class are represented to possess a unique combination of hydrolytic stability, toughness, flexibility, and relatively low temperature processability.

U.S. Pat. No. 5,863,627, which is also incorporated herein by reference, teaches preparing a class of biodurable, biocompatible polycarbonate-polyurethane compounds and using such polymers in or as medical devices. This patent teaches, for example, that the biodurable, biocompatible block copolymers prepared according to the teachings of this patent can be fashioned into small diameter vascular grafts. Additional valuable uses for these biodurable, biocompatible copolymers would be in coating a medical device fabricated from a metal or having a metallic core.

On the one hand, it has been found that polyester and/or polyether based polyurethane compounds, such as those described in the aforementioned '208 patent, are vulnerable to hydrolysis attacks, may suffer from metal ion oxidation, or may not be entirely resistant to deterioration over extended time periods from exposure to bodily fluids, enzymes, and the like. On the other hand, however, it has been found that, in coating applications, the polycarbonate-polyurethane compounds of U.S. Pat. No. 5,863,627 typically do not adhere well directly to an underlying metallic substrate. If such a coating were to flake off or peel away from a coated stent after it was in place in a coronary artery, the results could be disastrous. Even if the coating remained substantially intact, a loose bond between the underlying metal and the coating could permit blood (or other bodily fluid) to contact and corrode the metal thereby contaminating the blood/fluid and/or causing a bioincompatibility reaction. Such problems have limited the medical device coating applications for the copolymers of U.S. Pat. No. 5,863,627.

These and other problems with and limitations of the prior art in this field are addressed in whole, or at least in part, by the biodurable, biocompatible copolymers and the tie-coat copolymers of this invention and medical device products using one or both of such biocompatible and tic-coat polymers according to this invention.

### OBJECTS OF THE INVENTION

Accordingly, a general object of the present invention is to provide improved biodurable, biocompatible copolymers and also copolymers that are particularly useful in tie-coat applications together with the biocompatible copolymers of this invention.

Another general object of this invention is to provide methods for preparing the biocompatible copolymers and the tie-coat copolymers of this invention.

Still another general object of this invention is to provide products, especially biocompatible medical device products, which utilize the biocompatible and tie-coat copolymers of this invention.

A specific object of this invention is to provide polyurethane copolymers having polycarbonate backbones which demonstrate especially desirable biodurability and biocompatibility properties.

Another specific object of this invention is to provide polyurea or polyurethane-polyurea copolymers which demonstrate especially desirable tie-coat properties, especially when used in combination with the polycarbonate-polyurethane biocompatible copolymers of this invention.

Still another specific object of this invention is to provide biocompatible medical device products wherein a polyurea or a polyurethane-polyurea copolymer tie-coat according to this invention is applied as a first-layer coating to a metal substrate, and thereafter a biodurable, biocompatible polycarbonate-polyurethane copolymer according to the present invention is applied as a second-layer coating.

Still another specific object of this invention is to provide biocompatible medical device products wherein a polyurea or a polyurethane-polyurea copolymer tie-coat according to this invention is applied as a first-layer polymer coating to the surface of a cobalt-chromium medical device, such as a coronary artery stent, and thereafter a biodurable, biocompatible polycarbonate-polyurethane copolymer according to the present invention is applied as a second-layer polymer coating.

Still another specific object of this invention is to provide biocompatible medical device products wherein a polyurea or a polyurethane-polyurea copolymer tie-coat according to this invention is applied as a first-layer polymer coating to the surface of a cobalt-chromium medical device, such as a coronary artery stent, which has been prepared with a polished metal (such as a palladium-platinum) coating, and thereafter a biodurable, biocompatible polycarbonate-polyurethane copolymer according to the present invention is applied as a second-layer polymer coating over the copolymer tie-coat.

Yet another specific object of this invention is to securely apply a polycarbonate-polyurethane copolymer according to this invention as a coating or layer to a metallic surface or substrate and to incorporate one or more useful additives, such as drugs, into such a coating.

These and other objects and advantages of the present invention will be apparent from the following description and the illustrative drawings as discussed below.

### SUMMARY OF THE INVENTION

In a first general embodiment, this invention comprises a first-type of polycarbonate-polyurethane (hereinafter “P—P”) copolymers having advantageous biocompatibility and biodurability properties formed using polycarbonate polyols and polyisocyanates. Such copolymers are herein defined by the process and components used to prepare them because there is no other accepted way to describe or identify these copolymers.

In another embodiment, the polycarbonate polyols used in forming the first-type P—P copolymers of this invention are selected from the group consisting of polycarbonate polyols manufactured by condensation polymerization or transesterification. Polycarbonate diols used in the reaction with various di-, tri-, and higher polyisocyanates are typically manufactured by the reaction of an aliphatic diol and a dialkyl carbonate. A number of polycarbonate diols are commercially available under various tradenames. Several patents, such as U.S. Pat. No. 4,160,853, which is incorporated herein by reference, teach processes for preparing polycarbonate diols. A representative member of the group, poly(hexamethylenecarbonate) glycol (or diol), would be shown as follows:

HO—[(CH₂)₆—O—(C═O)—O]—(CH₂)₆—OH

In another embodiment, the polyisocyanates used in forming the first-type P—P copolymers of this invention are selected from aliphatic and aromatic diisocyanates and polyisocyanates, wherein the term “polyisocyanate” is used herein to describe isocyanate compounds having more than two isocyanate chemical groups.

In another embodiment, the di- and polyisocyanates used in forming the first-type P—P copolymers of this invention are selected from the group consisting of aliphatic diisocyanates and aliphatic polyisocyanates. Examples of useful aliphatic diisocyanates include: methylene-bis(4-cyclo-hexylisocyanate) (also known as “Desmodur W” from Bayer and as “H₁₂NDI” from Degussa); hexamethylene diisocyanate from Bayer; and isophorone diisocyanate.

In another embodiment, the di- and polyisocyanates used in forming the first-type P—P copolymers of this invention are selected from the group consisting of aromatic diisocyanates and aromatic polyisocyanates.

In a preferred embodiment, the di- or polyisocyanate is selected from the group consisting of toluene diisocyanate (TDI); methylene bis-phenylisocyanate (diphenylmethane diisocyanate) (MDI); hexamethylene diisocyanate (HDI); naphthalene diisocyanate (NDI); methylene bis-cyclohexylisocyanate (hydrogenated MDI or HMDI); isophorone diisocyanate (IPDI); and tetramethylxylylene diisocyanate (TMXDI). In a particularly preferred embodiment, the di- or polyisocyanate is methylene-bis(4 phenylisocyanate), which is the 4,4′ isomer of methylene diphenyl diisocyanate, also known as 4,4′-MDI and sometimes as “pure MDI”. These isocyanate products are commercially available under a number of trade names, e.g. Centari, heron, Nacconate, Rubinate, Desmodur, Isonate, Niax, Hylene, Mondur, and PAPI.

It has been found that polyurethane polymer molecules based on PEGs [poly (ethyleneglycols)] are inherently more susceptible to hydrolysis, and may be at least partially soluble in water or blood-sera environments. While they make good polymers for some applications, they are not suitable for body implants. The PU polymers based on poly (propylene glycols) are more hydrolysis resistant than are the PEG types, and the PU polymers based on poly (tetrahydrofuran), the PTMEG polyols, are even more hydrolysis resistant, but still are inferior to the polycarbonate polyol based PU polymers of this invention in hydrolysis and also relative to metal ion oxidation in situ. Also, use of the aromatic diisocyanates in making suitable primers or tie-coats for application inside the body opens the possibility that in-situ hydrolysis could form an aromatic amine compound, many of which are potentially carcinogenic.

In another embodiment, the first-type P—P copolymers according to this invention are prepared by the general sequential steps of:
(1) Premelting a suitable solid polycarbonate, typically having a MW of 2,000 (˜56 OH) or 1,000 (˜112 OH).
(2) Charging a suitable polyol(s) into a reactor (whether a glass reaction flask in a laboratory environment or a large commercial production reactor).
(3) Adding the other ingredients, usually preferably with agitation, into a “warm” reactor heated sufficiently to prevent the solidification of the PC diol. Other ingredients that may optionally be added at this step include one or more anti-oxidants; waxes for aid in molding, pellerizing, and extruding PUs such as TPUs; phosphites as color stabilizers; modifying polyols to modify certain physical and/or chemical characteristics of the mix; air-release additives; dyes; solids such as Cabosils or other platy or more spherical solids; metal salts such as barium salts; and other heavy metal salts which can be added for a variety of purposes, such as to provide radio-opacity to the final polymer.
(4) Melting the mix of polyols and added ingredients (if any), typically at a temperature of about 20 to 100° C.
(5) Degassing the polyol mix, typically at about 25 to 29 inches of mercury, while it is being agitated, to remove trapped gasses and especially moisture (which changes the polymer because moisture reacts with di- and poly-isocyanates to form ureas).
(6) Breaking the vacuum with nitrogen gas.
(7) Adjusting the temperature as appropriate to maintain the fluidity of the mix, and optionally taking samples to measure hydroxyl number and/or viscosity of the mix at this stage.
(8) Adding the isocyanate(s) at this point in the reaction process. Depending upon which isocyanates (di-isocyanates or polyisocyanates) are used, the reactor may be jacketed with an external water/steam cooling or heating jacket (or provided with internal heating/cooling coils), such that the batch temperature can be adjusted prior to introducing the di- and/or polyisocyanate(s).
(9) After mixing the ingredients to a substantially homogeneous condition, adding one or more polymerization catalysts to control the reaction and cause a condensation reaction to proceed. Typical catalysts may be amines (usually tertiary amines), organo-metallic catalysts, such as di-valent or tetra-valent tin salts, bismuth salts, titanium salts, etc., as are known in this art.
(10) Controlling the reaction temperature, usually to about 80 to 110° C. for most prepolymer-type polyurethanes. Alternatively the temperature may be allowed to exotherm to higher temperatures, for example for TPUs. Reactive hot melt PU adhesives usually fall in between coating prepolymers and TPUs.
(11) Cooking or reacting the polymer mix batch until the desired copolymerization end-point is reached, typically determined for example by viscosity or % NCO as an indication of molecular weight.
(12) Degassing the batch again to remove dissolved gasses, such as nitrogen, which may have dissolved into the prepolymer or copolymer. After final degassing, the agitation is usually stopped and the polymer mix batch is carefully discharged into containers, usually blanketed with nitrogen, and sealed.
(13) In the case of TPUs, the reaction may be made in two primary ways, with several possible modifications as desired:
   (A) In the prepolymer method, a urethane prepolymer is made and the resulting prepolymer is reacted to a specific % NCO determination point or to a preselected viscosity point. At some time after the prepolymer has been found to be “in specs” for % NCO, the proper amount of curative is calculated for the desired NCO/OH ratio, Typical curvatives, also called extenders, may be 1,4-butane diol, 1,6-hexane diol, or similar reactive compounds to create the desired TPU polymer, having particular durometer characteristics, T&E values, solvent solubility, etc.
   (B) In a second TPU preparation route, the TPU may be made in a “one-shot” method, wherein all the ingredients are added to the reactor, except the polyisocyanate(s); the ingredients are mixed, the temperature is adjusted as required, the di- or polyisocyanate(s) are added, the batch is further mixed for a specific time from a starting batch temperature, and the rapidly curing batch is poured into (usually Teflon-lined) pans or boxes and usually placed in an oven for curing.

When aliphatic diisocyanates or polyisocyanates, are used, it is usually desirable to add a reaction catalyst, either before or immediately after the isocyanates have been added and mixed. The uncatalyzed aliphatic isocyanate reaction mixture will eventually cure by itself, but this takes such a length of time that this procedure is usually not practical.

It will be understood, however, that this is merely an illustrative set of process steps, and such steps can be modified within limits that would be understood by one skilled in this art depending, for example, on how the polycarbonate diol polyurethane is made.

In a preferred embodiment, the first-type P—P copolymers of this invention will have molecular weights ranging from about 500 to about 6000.

In another preferred embodiment, the first-type P—P copolymers of this invention include one or more additives selected, and present in proportions effective, to impart certain desired physical and/or chemical and/or medical properties to the first-type P—P copolymers. Such additives may include, for example, drugs, antioxidants, anti-inflammatory agents, stabilizers, UV absorbers, colorants, pigments, dyes, and combinations of two or more of such additives in effective amounts.

In another embodiment, the first-type P—P copolymers of this invention are prepared as solids and are stored in pelletized or resin bead form for subsequent coating applications.

In another embodiment, a first-type P—P copolymer according to this invention is dissolved in a suitable solvent in preparation for a coating application, and one or more additives as desired can be added to such a solution. Solvents for the first-type P—P copolymers of this invention are preferably selected from the group consisting of dimethylformamide, dim ethylacetamide, tetrahydrofuran, dimethylsulfoxide, and any solvents that are sufficiently polar or “good” solvents for the polar polycarbonate polyurethane, whether the P—P polymer is a TPU, a cured elastomer, or either —N═C═O or —OH terminated prepolymer, etc. are useful as solvents for the P—P copolymer, particularly the TPU P—P copolymers. As noted above, examples are dimethyl formamide, dimethyl acetamide, dimethyl sulfonamide, and higher homologs or analogs of such materials. Other useful polar solvents include the acetates (for example, ethyl acetate, butyl acetate, etc.), ketones (for example, methyl ethyl ketone, methyl amyl ketone, etc.), and so on.

Similar solvents, such as certain non-polar or slightly polar solvents also are used as solvents for P—P copolymers, whether the PU is a prepolymer, a solvent-based coating, adhesive, etc., a reactive polyurethane, a reactive hot melt PU adhesive, or amine-extended polyurethane-polyurca, or polyol extended PU, such as the TPUs. Solvents of this type may be tetrahydrofuran, toluene, and the like.

N-methylpyrroliclinone is useful as a solvent, especially for coalescence of water-borne polyurethanes in general, and P—P urethanes specifically. Specific solvents that have been found of value in forming solutions of the P—P TPUs, and TPUs in general, are tetrahydrofuran and dimethylacetamide.

Solvents important in the spray application of copolymer solutions to stents and other medical and non-medical devices and parts include individual solvents, as mentioned above, and also blends of solvents designed for achieving a balanced combination of solvency of the copolymer, spray viscosity, and evaporation rates. Such solvent blends include the aforementioned THF-DMAc blends, and blends of THF and alcohols, such as ethanol, methanol, 1-propanol, 2-propanol, butanol, and the like. Mix ratios can be varied over a wide range of solvent components to obtain the desired properties of spray-ability, drying, copolymer deposit, smoothness of the applied copolymer solution, and the resulting dry copolymer and drug-copolymer mixtures.

It should be understood that some of the solvent blends that are sufficient for solution and spray applications of thecopolymer may not be suitable solvents for at least some of the drug(s) which may be desirable for incorporation in some of the copolymer-drug mixtures.

It should also be understood that the drug(s) used for various medical applications, such as anti-blood clotting, anti-inflammatory, and other applications of specific drug(s) may not be soluble in the desired copolymer-dissolving solvents.

In addition, there may be various modes of drug application and drug-copolymer application, such as the deposition of drugs directly on the stent or other medical or non-medical devices or parts, application of the drugs into cavities or “pores” specifically made on the metal or plastic stents and other devices, whose application may be followed by a layer, or layers, of copolymer solution to hold the drug in place and also to control the drug's elution rate. There may also be layers of drug(s) and copolymer applied in the desired solvents, or alternating layers of drugs) and copolymer solutions.

The desired drug(s), copolymer, or drug(s)-copolymer mixtures typically range from very dilute solutions, such as 0.01% solids, to a high concentration, such as 25%, where limited spray passes are desired, or maximum applied solid deposition is required. There are also possible drug(s) and copolymer or drug(s)-copolymer mixtures that can be applied by other means than spray application. Dipping the stents, other medical devices and other parts in the solution is an accepted application procedure, and it has been done with excellent results for purposes of this application. The above solvents for spray applications may also serve as excellent solvents to make a dipping solution of the drug(s), the copolymer(s) and the drug(s)-copolymer combinations in all desired variable concentration levels.

Multiple dipping of the part or piece into a solvent solution, or dipping into different solvent solutions, either using different solid or liquid drug(s) and copolymer components is another embodiment. By a suitable addition of flow-control additive, etc., excellent smooth coatings can be formed by either dipping or spray applications. Further, by the application of a water dispersion, such as PUD (polyurethane dispersion) or water-based emulsion, or other dispersion or emulsion types, it is possible to vary the copolymer and/or the drug(s) particle sizes and thereby control the applied coatings to realize such results as variation in smoothness of the coating, the concentration of drugs(s) in the individual particles, and potentially a “time-release” chemistry for controlled drug release for individual particles.

Such first-type P—P copolymer/solvent mixtures may advantageously comprise from about 0.1 to about 50 wt. % P—P copolymer to solvent, or in some cases, even higher proportions of P—P copolymer to solvent.

In another embodiment of this invention, a first-type P—P copolymer according to this invention, with or without additives, is applied as a coating to a metal or a coated metal surface by a method selected from the group consisting of: a spray or vacuum-spray operation; a powder coating operation; a flow-coating operation using either a hot, fluid copolymer or a copolymer solution; and a dipping operation.

In another general embodiment, this invention comprises the method of applying a primer coating or a tie-coat layer of a material having good adhesive or bonding properties relative to at least two different materials to a surface comprising a first of the two materials, and then over-coating the primer coating or tie-coat layer with a second of the two materials as a technique for securely coating a surface of the first material with the second material. In a specific application of this principle, the highly-polished surface of a metallic medical device designed to be implanted in a living body is coated first with a primer coating or tie-coat layer according to this invention, and thereafter a biocompatible layer (which may contain one or more additives such as drugs) is applied to over-coat the tie-coat layer and thereby form a biocompatible medical device.

In a specific embodiment, a cobalt (Co)-chromium (Cr) medical device, such as a coronary artery stent, is prepared. The metallic surface may then be electropolished, which makes it very difficult to adhere a biodurable, biocompatible material, such as the first-type P—P copolymers of this invention, to such a surface. Instead, the polished metal surface is first coated with a primer coating or tie-coat layer in accordance with this invention, and the tie-coat is then overcoated with a drug-containing biocompatible copolymer also according to this invention that adheres securely to the tie-coat layer.

In another specific embodiment, a cobalt (Co)-chromium (Cr) medical device, such as a coronary artery stent, is initially coated with a palladium (Pd)-platinum (Pt) metal coating. The Pd—Pt surface is then electropolished, which makes it very difficult to adhere a biodurable, biocompatible material, such as the first-type P—P copolymers of this invention, to such a surface. Instead, the polished Pd—Pt surface is coated first with a primer coating or tie-coat layer in accordance with this invention, and the tic-coat layer is then overcoated with a drug-containing biocompatible copolymer also according to this invention that adheres securely to the tie-coat layer.

In yet another general embodiment, this invention comprises a second-type of polycarbonate-polyurethane (P—P) copolymers modified to demonstrate superior adhesive properties relative to both metallic surfaces and to the first-type of P—P copolymers in accordance with this invention, as well as enhanced solubility in a suitable solvent. The second type P—P copolymers are formed in general by chain-extending an isocyanate-terminated first-type P—P copolymer with one or more diamines or polyamines, for example a mixture of aliphatic diamines, wherein the term “polyamine” is used to describe amines having more than two amine groups.

In specific embodiments, the second-type P—P copolymer of this invention is formed by chain-extending an isocyanate-terminated first-type P—P copolymer with a diamine or a polyamine selected, for example, from the group consisting of ethylene-diamine, 1,3-diaminocyclohexane, and mixtures thereof. The diamines and polyamines useful for chain-extension and “curing” of the second-type of P—P prepolymers include essentially all di- and poly-amines from ethylene diamine up through the higher homologs and analogs of these compounds. The only limitation on the selection of di- or polyamine is solely based on the ability of the material to be handled in the present application, and to react in the appropriate time scale with the —N═C═O, acidic, etc. functional groups of the prepolymer. Preferred di- and polyamines for this purpose include ethylene diamine, 1,2-propylene diamine, the various cyclohexylamines, benzyl amines, naphthyl amines, methylenebis(4-phenylamine) and similar, methylenebis(4-cyclohexylaminc), isophoronediamine, Two amines and so forth. Blends of amines are especially useful for modifying the physical properties of the resulting copolymer. Diamines useful as chain extenders for forming the second-type P—P copolymers of this invention are further described in U.S. Pat. No. 5,719,307, which is incorporated herein by reference.

In another embodiment, second-type P—P copolymers according to this invention are prepared by chain-extending suitable P—P copolymers with a diamine or a polyamine in accordance with the description and the examples hereinafter.

In another embodiment, a second-type P—P copolymer according to this invention is dissolved in suitable solvent in preparation for a coating application. Solvents for the second-type P—P copolymers of this invention are preferably selected from the group consisting of aromatic solvents including toluene, xylene and tetrahydrofuran, polar solvents including methyl alcohol, ethyl alcohol, 1-propanol and 2-propanol, and mixtures thereof.

In another embodiment of this invention, a second-type P—P copolymer according to this invention is applied as a primer coating or tie-coat layer to a metal surface or metal substrate, for example by spraying a solution of the second-type P—P copolymer on the metal surface, or dipping the metal surface into the solution, or by another suitable application technique.

In another embodiment of this invention, a second-type P—P copolymer according to this invention is applied as a primer coating or tie-coat layer to a metal surface, and subsequently a first-type P—P copolymer according to this invention, with or without additives, is applied as a second layer or over-coating over the tie-coat layer.

In still another embodiment, this invention comprises articles, particularly medical devices, fabricated at least in part by the steps of applying a second-type P—P copolymer as a primer coating or tie-coat layer to a metal surface of an article, and subsequently over-coating the tie-coat layer with a first-type P—P copolymer, said first-type P—P copolymer being with or without additives.

Specific preferred embodiments of the invention include:

(1) A first-type polycarbonate-polyurethane copolymer formed by the reaction of one or more polycarbonate polyols with one or more polyisocyanates.

(2) A first-type polycarbonate-polyurethane copolymer according to paragraph (1) wherein the polycarbonate polyol is a polycarbonate diol formed by the reaction of an aliphatic diol with a dialkyl carbonate.

(3) A first-type polycarbonate-polyurethane copolymer according to paragraph (1) wherein the polyisocyanate is selected from the group consisting of aliphatic and aromatic diisocyanates and polyisocyanates.

(4) A first-type polycarbonate-polyurethane copolymer according to paragraph (2) wherein the polyisocyanate is selected from the group consisting of aliphatic and aromatic diisocyanates and polyisocyanates.

(5) A first-type polycarbonate-polyurethane copolymer according to paragraph (1) wherein the polyisocyanate is selected from the group consisting of toluene diisocyanate (TDI); methylene bis-phenylisocyanate (diphenylmethane diisocyanate) (MDI); hexamethylene diisocyanate (HDI); naphthalene diisocyanate (NDI); methylene bis-cyclohexylisocyanate (hydrogenated MDI or HMDI); isophorone diisocyanate (IPDI); and tetramethylxylylene diisocyanate (TMXDI).

(6) A first-type polycarbonate-polyurethane copolymer according to paragraph (1) prepared by the sequential steps of:
(a) premelting the starting solid polycarbonate;
(b) charging one or a mix of polyols into a reactor;
(c) optionally adding other ingredients selected from the group consisting of: anti-oxidants; waxes for aid in molding, pellerizing, and extruding; phosphites as color stabilizers; modifying polyols; air-release additives; dyes; Cabosils or other platy or more spherical solids; and metal salts;
(d) melting the polyol mix at a temperature of about 20° C. to about 100° C.;
(e) degassing the polyol mix under partial vacuum conditions of about 25 to 29 inches of mercury while it is being agitated thereby removing trapped gasses and moisture;
(f) breaking the vacuum by adding nitrogen gas;
(g) adding the polyisocyanate(s) and a polymerization catalyst to the polyol mix and mixing the ingredients to form a substantially homogeneous polymerization mixture, wherein the polymerization catalyst is selected from the group consisting of: amines; organo-metallic catalysts; bismuth salts; and titanium salts;
(h) establishing and maintaining a polymerization reaction temperature for a sufficient period of time for the polymerization mixture to teach a desired molecular weight; and,
(i) degassing the reacted polymerization mixture to remove dissolved gasses.

(7) A first-type polycarbonate-polyurethane copolymer prepared according to the steps of paragraph (6) wherein the starting polycarbonate has a molecular weight ranging from about 1000 to about 2000.

(8) A first-type polycarbonate-polyurethane copolymer prepared according to the steps of paragraph (6) and additionally the step of adding an extender to the reacted polymerization mixture to form a thermoplastic polyurethane polymer mix having particular physical and/or chemical properties.

(9) A first-type polycarbonate-polyurethane copolymer prepared according to the steps of paragraph (8) wherein the extender is selected from the group consisting of 1,4-butane diol and 1,6 hexane diol.

(10) A first-type polycarbonate-polyurethane copolymer product comprising a predominant proportion of a first-type polycarbonate-polyurethane copolymer according to paragraph (1) mixed with an effective amount, effective to impart desired physical, chemical and/or medical properties to the copolymer product, of one or more additives selected from the group consisting of drugs, antioxidants, anti-inflammatory agents, stabilizers, UV absorbers, colorants, pigments and dyes.

(11) A first-type polycarbonate-polyurethane copolymer product comprising a first-type polycarbonate-polyurethane copolymer according to paragraph (1) dissolved in a suitable solvent.

(12) A first-type polycarbonate-polyurethane copolymer product according to paragraph (11) wherein the solvent is selected from the group consisting of dimethylformamide, dimethylacetamide, tetrahydrofuran, dimethylsulfoxide, acetates, ketones, and combinations thereof.

(13) A polycarbonate-polyurethane copolymer or a polycarbonate-polyurethane copolymer product according to any of paragraphs (1) -(12) further wherein at least an isocyanate-terminated chain of the first-type polycarbonate-polyurethane copolymer has been chain-extended by reaction with a diamine, a polyamine, or mixtures thereof to form a second-type polycarbonate-polyurethane copolymer.

(14) A polycarbonate-polyurethane copolymer or a polycarbonate-polyurethane copolymer product according to any of paragraphs (1)-(12) further wherein at least an isocyanate-terminated chain of the first-type polycarbonate-polyurethane copolymer has been chain-extended by reaction with a diamine, a polyamine, or mixtures thereof to form a second-type polycarbonate-polyurethane copolymer, wherein the chain-extension reaction is with a diamine selected from the group consisting of ethylene-diamine, 1,2 propylene diamine, 1,3 diaminocyclohexane, isophoronediamine and mixtures thereof, or with a polyamine selected from the group consisting of cyclohexylamines, benzyl amines, naphthyl amines, methylenebis (4-phenylamine), TMXD amines and mixtures thereof.

(15) A second-type polycarbonate-polyurethane copolymer formed by chain-extending a first-type polycarbonate-polyurethane copolymer according to any of paragraphs (1)-(12) by reacting at least an isocyanate-terminated chain of the first-type polycarbonate-polyurethane copolymer with a diamine, polyamine or mixture thereof.

(16) A second-type polycarbonate-polyurethane copolymer product wherein a first-type polycarbonate-polyurethane copolymer according to any of paragraphs (1)-(12) is formed by the reaction of one or more polycarbonate polyols with one or more polyisocyanates, the first-type polycarbonate-polyurethane copolymer is chain extended by reacting at least an isocyanate-terminated chain of the first-type polycarbonate-polyurethane copolymer with a diamine, polyamine or mixture thereof to form a second-type polycarbonate-polyurethane copolymer, and the second-type polycarbonate-polyurethane copolymer is dissolved in a suitable solvent.

(17) A second-type polycarbonate-polyurethane copolymer product according to paragraph (16) wherein the solvent is selected from the group consisting of aromatic solvents, polar solvents and mixtures thereof.

(18) A second-type polycarbonate-polyurethane copolymer product according to paragraph (17) wherein the solvent is an aromatic solvent selected from the group consisting of toluene, xylene and tetrahydrofuran and mixtures thereof, or the solvent is a polar solvent selected from the group consisting of methyl alcohol, ethyl alcohol, 1-propanol, 2-propanol and mixtures thereof.

(19) An article having an article surface, wherein at least a portion of the article surface is coated with a first-type polycarbonate-polyurethane copolymer or a first-type polycarbonate-polyurethane copolymer product, wherein the first-type polycarbonate-polyurethane copolymer is formed by the reaction of one or more polycarbonate polyols with one or more polyisocyanates.

(20) An article having an article surface, wherein at least a portion of the article surface is sequentially coated, first, by a coating of a second-type polycarbonate-polyurethane copolymer and, second, by a coating of a first-type polycarbonate-polyurethane copolymer or a first-type polycarbonate-polyurethane copolymer product, wherein the first-type polycarbonate-polyurethane copolymer is formed by the reaction of one or more polycarbonate polyols with one or more polyisocyanates, and the second-type polycarbonate-polyurethane copolymer is formed by the reaction of one or more polycarbonate polyols with one or more polyisocyanates followed by chain-extending at least an isocyanate-terminated chain of the resulting copolymer with a diamine, polyamine or mixture thereof.

(21) An article according to paragraph (20) wherein the polycarbonate polyols and the polyisocyanates used in preparing the second-type polycarbonate-polyurethane copolymer are the same as those used in preparing the first-type polycarbonate-polyurethane copolymer.

(22) An article according to paragraph (20) wherein said first-type polycarbonate-polyurethane copolymer product comprises a predominant proportion of the first-type polycarbonate-polyurethane copolymer mixed with an effective amount, effective to impart desired physical, chemical and/or medical properties to the copolymer product, of one or more additives selected from the group consisting of drugs, antioxidants, anti-inflammatory agents, stabilizers, UV absorbers, colorants, pigments and dyes.

(23) An article according to any of paragraphs (19)-(22) wherein the article surface is a metal surface.

(24) An article according to any of paragraphs (19)-(22) wherein the article surface is a cobalt-chromium alloy surface.

(25) An article according to any of paragraphs (19)-(22) wherein the article surface is a cobalt-chromium alloy surface that has been coated with a palladium-platinum coating.

(26) A method of fabricating an article having a coated article surface, at least a portion of the coated article surface being coated with a first-type polycarbonate-polyurethane copolymer, said method comprising the steps of:

(a) forming a first-type polycarbonate-polyurethane copolymer by the reaction of one or more polycarbonate polyols with one or more polyisocyanates;

(b) forming a solution of the first-type polycarbonate-polyurethane copolymer in a suitable solvent, a suspension of the first-type polycarbonate-polyurethane copolymer in a suitable fluid carrier, or a melt of the first-type polycarbonate-polyurethane copolymer; and

(c) applying the first-type polycarbonate-polyurethane copolymer solution, suspension or melt to the article surface.

(27) A method according to paragraph (26) wherein step (c) is carried out at least in part by a step of spraying, vacuum-spraying, powder coating, flow-coating or dipping.

(28) A method of fabricating an article having a coated article surface, at least a portion of the coated article surface being sequentially coated, first, by a coating of a second-type polycarbonate-polyurethane copolymer and, second, by a coating of a first-type polycarbonate-polyurethane copolymer or a first-type polycarbonate-polyurethane copolymer product, said method comprising the steps of:

(a) forming the first-type polycarbonate-polyurethane copolymer by the reaction of one or more polycarbonate polyols with one or more polyisocyanates;

(b) forming the second-type polycarbonate-polyurethane copolymer by the reaction of one or more polycarbonate polyols with one or more polyisocyanates followed by chain-extending at least an isocyanate-terminated chain of the resulting copolymer with a diamine, polyamine or mixture thereof;

(c) forming a solution of the first-type polycarbonate-polyurethane copolymer in a suitable solvent, a suspension of the first-type polycarbonate-polyurethane copolymer in a suitable fluid carrier, or a melt of the first-type polycarbonate-polyurethane copolymer;

(d) forming a solution of the second-type polycarbonate-polyurethane copolymer in a suitable solvent, a suspension of the second-type polycarbonate-polyurethane copolymer in a suitable fluid carrier, or a melt of the second-type polycarbonate-polyurethane copolymer;

(e) applying the second-type polycarbonate-polyurethane copolymer solution, suspension or melt to the article surface; and,

(f) applying the first-type polycarbonate-polyurethane copolymer solution, suspension or melt to the article surface over the coating of the second-type polycarbonate-polyurethane copolymer.

(29) A method according to paragraph (28) wherein steps (e) and (f) are carried out at least in part by a step of spraying, vacuum-spraying, powder coating, flow-coating or dipping.

(30) A method according to paragraph (28) wherein the polycarbonate polyols and the polyisocyanates used in preparing the second-type polycarbonate-polyurethane copolymer are the same as those used in preparing the first-type polycarbonate-polyurethane copolymer.

(31) A method according to paragraph (28) wherein said first-type polycarbonate-polyurethane copolymer product comprises a predominant proportion of the first-type polycarbonate-polyurethane copolymer mixed with an effective amount, effective to impart desired physical, chemical and/or medical properties to the copolymer product, of one or more additives selected from the group consisting of drugs, antioxidants, anti-inflammatory agents, stabilizers, UV absorbers, colorants, pigments and dyes.

(32) A method according to any of paragraphs (26)-(31) wherein the article surface is a metal surface.

(33) A method according to any of paragraphs (26)-(31) wherein the article surface is a cobalt-chromium alloy surface.

(34) A method according to any of paragraphs (26)-(31) wherein the article surface is a cobalt-chromium alloy surface that has been coated with a palladium-platinum coating.

### BRIEF DESCRIPTION OF THE DRAWINGS

FIG. 1 is a schematic cross-sectional illustration of an embodiment of the present invention wherein a cross-section of a portion of an article or an object, such as a medical device, comprises a metallic core or element, including a metal or metal alloy surface, a tie-coat polymer coating according to this invention, and an outer layer or coating of a biodurable, biocompatible material according to this invention.

FIG. 2 is a schematic cross-sectional illustration of another embodiment of the present invention wherein a cross-section of a portion of an article or an object, such as a medical device, comprises a metallic core or element, including a metal or metal alloy surface, a coating or layer of another metal or metals, a tie-coat polymer coating according to this invention, and an outer layer or coating of a biodurable, biocompatible material according to this invention.

### DESCRIPTION OF PREFERRED EMBODIMENTS OF THE INVENTION

### A. Polycarbonate-Polyurethane Polymers of this Invention

Cardiac implantable stents, which are preferably designed to be drug eluting stents (DES), have been developed in recent years. Such a stent can be made for example from a Co—Cr (cobalt-chromium) alloy, which is then typically coated with a mixture of Pd—Pt (Palladium-Platinum) by methods that are well known in this art. This alloy stent may then be over-coated with a drug-containing urethane polymer. Because of the expectation that this implanted stent will remain in the body for a lifetime, a urethane polymer having the properties of high biodurability and high biocompatibility should be used.

It is known in the art to form polyurethane prepolymers from a polyisocyanate and a polyol. U.S. Pat. No. 4,647,646, which is incorporated herein by reference, teaches the preparation of heat curable compositions, particularly solvent-based adhesive compositions, based on a polyurethane prepolymer formed by reacting a polyisocyanate and a polyol. Four polyols that can be used to make a drug-carrying polyurethane polymer are:

1. Polyether polyols of the PPG [poly(propylcne glycol)] or PEG [poly(ethylene glycol)] type.

2. Polyether polyols of the PTMEG [poly(tetramethyleneether glycol)] type.

3. Polyesters, as are typically made from a glycol (such as ethylene, propylene, butylenes, hexane, etc.) diols, and a dibasic acid (such as adipic, azelaic, phthalic and the like).

4. A special type of polyester polyol, known in the art as a polycarbonate polyol.

The first three of these four polyol types that could, in general, be used to make a polyurethane polymer have been found to result in polymers that are vulnerable to hydrolysis attacks, which degrade the polymer and may cause polymer particles to be released into the blood stream, with subsequent potentially serious results. These polymers may also suffer metal ion oxidation, thereby also degrading the polymer. These polymers may also be vulnerable to attack by aggressive body fluids that can render the polymer coating, in the preferred case a drug-eluting polymer coating, useless in just a few weeks, months or years of exposure to body fluids, such as attacking enzymes and the like. Polyester-based polyurethanes are widely used in industry, but they have been found to be hydrolytically unstable. Increasingly, such polyester-based polyurethanes are being replaced by polyether polyurethanes, which are inherently more hydrolytically stable. These polyether polyurethanes, however, have been found to be oxidation sensitive, for example to metal ion oxidation, etc. The in vivo instability of both the polyester and the polyether polyurethanes renders both of these types of polyurethanes, and products made from them, generally undesirable for implantable medical devices.

The relatively recent development of polycarbonate-based polyurethanes as represented, for example, by aromatic polycarbonate-TPU (thermoplastic polyurethane) polymers and aliphatic polycarbonate-TPU polymers, as generally taught in U.S. Pat. No. 5,863,627, eliminated many of the problems experienced with polyester- and polyether-based polyurethanes in coating applications. The polycarbonates in these polymers function as the “soft-segment” component of both the aromatic and aliphatic polyurethanes, including TPUs, coatings, adhesives, molded and extruded devices and the like. In addition, it has been found that various additives, such as typical anti-oxidants, used in making such polycarbonate-based polyurethane polymers, can act as anti-inflammatory agents. Anti-oxidants, such as Vitamin E, incorporated into the polymer function well as the antioxidants in these polycarbonate-based polyurethanes.

It has now been found that one special type of polycarbonate-based polyurethane copolymers provides especially excellent resistance to all of the various degradation phenomena and conditions that can occur inside the body. Such a class of copolymers is based on a polycarbonate polyol that functions as the “soft segment” portion of a polycarbonate-polyurethane copolymer. For aliphatic polycarbonate-polyurethane copolymers made from these polycarbonate polyols, aliphatic diisocyanates, such as methylene-bis(4-cyclohexylisocyanate), isophorone diisocyanate or polyisocyanates, may be used, For aromatic polycarbonate-polyurethanes, methylene-bis(4phenylisocyanate) and similar aromatic diisocyanates or polyisocyanates may be used.

Polycarbonate polyols, when used in polyurethane prepolymers and copolymers, have been found to provide outstanding physical properties such as flexibility, hydrolysis resistance, chemical stability, and elasticity, as well as resistance to oxidation by metal ion oxidation and the various attacks that may occur on a foreign object placed inside the human body. Polycarbonate polyols having molecular weights between about 500 to about 6,000 have been found to make particularly excellent polycarbonate-polyurethane copolymers which are useful in a wide variety of applications, including coatings, adhesives, castable urethanes, TPUs and the like. Such copolymer coatings, adhesives, etc., may be formed in solvents, or the copolymer may be made as essentially 100% solids and then dissolved in a suitable, desired solvent(s).

It has further been found that adding polycarbonate components, in accordance with this invention, to epoxy compositions can impart excellent physical and chemical properties to the epoxy products, for example by reacting the polycarbonates with epoxides or by reacting the polycarbonate polyols with acids, with acid anhydrides, and the like.

Thus, polycarbonate-based TPU copolymers demonstrate excellent chemical resistance, resistance to hydrolysis, resistance to metal ion oxidation, and excellent drug carrying capability as desired for a drug-eluting stent intended for long term residence inside a human body. The copolymer formulation would normally preferably also contain such additives as antioxidants, chemical stabilizers, a wax or similar material for lubrication during post-processing, and possibly such other additives as UV absorbers, colorants, inorganic pigments, dyes, and other additives as are known in this art which are compatible with the copolymers of this invention and with the intended applications of the copolymers.

### B. Illustrative Applications for the Copolymer Coatings of this Invention

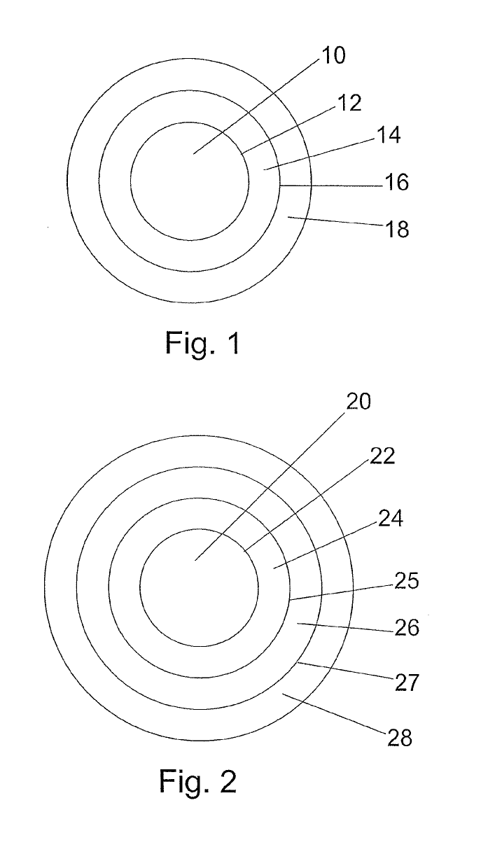

FIGS. 1 and 2 illustrate two representative applications for the copolymer coatings, particularly the paired combination of a biocompatible/biodurable copolymer coating with a copolymer tie-coat, according to this invention. It will be understood that, in FIGS. 1 and 2, the widths of the various respective layers or coatings have been greatly exaggerated relative to the diameters of the coated objects for illustrative purposes.

FIG. 1 is a schematic cross-section of a portion of a polymer-coated article or object 10, which advantageously may comprise a medical device, such as a cardiac stent, intended to be implanted in a living body. The object 10 may comprise a solid object or, alternatively, object 10 may be a stent, tube, or conduit having a substantially hollow interior designed to carry a fluid, such as blood. In either case, object 10 is defined by an external surface 12 that is typically comprised of a metal or metallic alloy, such as a cobalt-chromium alloy, for structural integrity.

In order to impart biocompatibility/biodurability properties to article 10, the article surface 12 is advantageously coated with or covered by a layer of a biocompatible/biodurable polycarbonate-polyurethane copolymer in accordance with this invention, which may optionally be impregnated with drugs, dyes or other materials to impart special properties. Because surface 12 of article 10 may be a polished metal surface or may otherwise not provide a suitable surface for directly adhering a layer of the polycarbonate-polyurethane copolymer, however, in accordance with this invention a layer or coating 14 of a tie-coat copolymer is applied or coated by suitable techniques as described hereinafter directly on surface 12 of article 10. Layer 14 acts as a binding or adhesive coating for subsequent application of the biocompatible/biodurable copolymer. After coating 14 has been applied to surface 12 and dried and/or solidified, a biocompatible/biodurable polycarbonate-polyurethane copolymer layer 18 according to this invention may then be successfully applied to or overcoated on the outer surface 16 of tie-coat layer 14 to form the polymer-coated device. Drugs, dyes or other materials selected to impart special properties may be incorporated into copolymer layer 18 before, during or after it is applied to tie-coat layer 14.

FIG. 2 is generally similar to FIG. 1 in showing a schematic cross-section of a portion of a polymer-coated article 20, which also may comprise a medical device. Similar to article 10 in FIG. 1, article 20 in FIG. 2 may be a solid object or a hollow object such as a stent. Article 20 is defined by an external surface 22 and may be comprised of a metal or metallic alloy, such as a cobalt-chromium alloy. Article 20 in FIG. 2, however, further comprises a layer 24 of a metal coating applied to the article surface 22 of article 20. In a preferred embodiment for medical applications, layer 24 comprises a mixture of palladium and platinum, which is typically highly polished thereby making it especially difficult to reliably adhere a biodurable polymer coating to such a surface.

Instead, in accordance with this invention, a layer or coating 26 of a tie-coat copolymer is applied or coated by suitable techniques as described hereinafter directly on surface 25 of the palladium-platinum layer 24. Layer 26 acts as a binding or adhesive coating for subsequent application of the biocompatible/biodurable copolymer. After coating 26 has been applied to surface 25 and dried and/or solidified, a biocompatible/biodurable polycarbonate-polyurethane copolymer layer 28 according to this invention may then be successfully applied or overcoated on the outer surface 27 of tie-coat layer 26 to form the polymer-coated device. Drugs, dyes or other materials selected to impart special properties may be incorporated into copolymer layer 28 before, during or after it is applied to tie-coat layer 26.

### C. Methods of Coating a Surface

A preferred application method to coat a stent or another medical device with the polycarbonate-polyurethane copolymers of this invention is to prepare a TPU from the desired polycarbonate polyol and the desired diisocyanate (or multi-functional isocyanate). The TPU is reacted, and it can then be cast into blocks, films or cakes, and given a thermal treatment to cure, or post-cure, the copolymer. The resulting copolymer may then be cut into small pieces and pelletized into resin bead form. These pellets are storage-stable for very long periods of time, and usually comprise hydroxyl-terminated polyurethane copolymers. However, there are many variations to the possible “end groups” on these completed polymer chains.

The resin beads can then be dissolved into the desired solvent(s) in preparation for application to a surface, a pre-determined drug dose level (and/or one or more other additives) may be added to and mixed into the mixture, and the substantially homogenous copolymer-drug mixture can then be applied to the surface of the stent in any conventional method, such as by a spray or a vacuum-spray operation, and similar processes as are known in the art.

There are many other application methods, however, that can be used to apply the copolymer-drug homogenous mixture to the stents or other medical devices, such as by powder coating; by flow-coating using either a hot, fluid copolymer or a copolymer solution; and by various dipping operations. In one exemplary embodiment, a stent could be electrically charged, or heated, and then dipped into a powder coating fluid bed to coat the stent with the desired coating of copolymer or copolymer-drug homogenous mixture. In an alternative embodiment, a gas deposition of the hot copolymer and drug mixture might be carried out, either at ambient conditions or in a vacuum application. In still another embodiment, a stent could be coated with a mixture or sequential layers of the required starting materials, as described previously, a mixture which could contain one or more additives such as drugs, UV absorbers, antioxidants, catalysts, and other desired components. Thereafter, an in-situ copolymerization could be carried out to form the first-type polycarbonate-polyurethane copolymer.

In a representative embodiment, polycarbonate-based TPUs were dissolved in preferred solvents, anti-restenosis drug(s) were added, the mixture was then spray-applied under ambient conditions to the surface of a metal stent, and the solvent(s) were evaporated, leaving a more-or-less uniform coating of polycarbonate-polyurethane copolymer and substantially homogenously distributed drug mixture,

### D. Tie-Coat Polymers of this Invention

A particularly useful cardiovascular stent can be fabricated from a cobalt-chromium alloy that is then overcoated with a palladium-platinum mixture, as illustrated in FIG. 2. The palladium-platinum surface may then be micropolished. Due to the inert nature of the Pd—Pt surface of such a Co—Cr metal stent, which may have been micropolished by an electropolishing technique (which is known in the industry), it has been heretofore difficult to successfully coat such medical devices with biocompatible polymer coatings. It has been found, for example, that, in general, polymer-drug mixtures, whether applied by spraying or by dip-coating into the polymer-drug solutions, have relatively poor adhesion to the polished Pd—Pt surface of such a Co—Cr metal stent. It was found, for example, that the polymer-drug coating so applied could fairly easily be scraped or rubbed off of the metal surfaces of these stents.

Poor adhesion of the coating could lead to possible serious medical conditions resulting from polymer, polymer pieces and even larger sections of polymer being removed from the stent in vivo, becoming entrained in the blood stream, and traveling to the heart and other organs, where disastrous effects might ensue.

Many stent coatings of various compositions, not within the scope of this invention, such as polyurethane dispersions, silane-containing polymer solutions, isocyanate-terminated polymers, as well as hydroxyl-terminated polymers were evaluated for comparison with coatings in accordance with the present invention. None of the coatings outside the scope of this invention, however, were deemed acceptable for the rigorous conditions in which these stents were to be used.

A part of this invention therefore also included developing a novel “primer” or tie-coat polymer, which would demonstrate good adhesion to a highly-polished metal surface of a stent when applied by spraying, dipping and similar application techniques. In addition, such a primer or tie-coat coating also would need to demonstrate excellent adhesion to an over-coated TPU polymer (and possibly drug-containing coating), thus bonding securely to both the underlying metal stent surface and to the over-coated TPU-drug polymer layer.

Because the polycarbonate-based TPUs have a very high cohesive energy density, the pelletized or other physical forms of these copolymers are typically extremely difficult to dissolve in common organic solvents. Therefore, very strong, either polar or non-polar, solvents are necessary to dissolve the copolymer and the drug (if any) or other additives being added to the copolymer solution/mixture. Typical useful solvents include dimethylormamide, demethylacetamide, tetrahydronfuran, dimethylsulfoxide and the like. It was found that these solutions/mixtures could then be effectively spray-applied, dipped-applied, etc. to the primer-coated stent. Because of the strengths of the solvents required for this purpose, however, there would be a high likelihood that they would at least partially dissolve away the dried or cured primer tie-coat layer previously applied to the stent. In some tests, the strong applied solvents would swell the applied primer or tie-coat, causing at least partial failure with the result that the biocompatible copolymer-drug coating would not properly adhere to the stent, with or without the primer coating being used.

Therefore, it was necessary to develop a primer tie-coat polymer for this biocompatible copolymer/tie-coat system wherein:
1. The tie-coat polymer would dissolve easily in common, non-hazardous solvents to facilitate easy application;
2. The tie-coat polymer solvents would typically dry quickly for process efficiencies; and,
3. The tie-coat polymer would form a dried or cured film that would not be substantially affected by the over-spraying, dipping, or other such application methods of the biocompatible copolymer-drug-solvent mixture.

Such a tie-coat polymer would have to have a higher energy density than the very strong solvent solution of the copolymer-drug-solvent mixture, such that the second coating solution would not dissolve away or significantly damage the first (primer tie-coat) polymer layer. It was also preferable that any solvents used to form the primer or tie-coat solution would not be slow in evaporating in order to prevent trapping solvent that could possibly find its way into a patient's body after the medical device was completed and placed in vivo.

In accordance with this invention, it was found that a polyurea polymer, or a polyurethane-polyurea copolymer, was optimally suited for the primer tie-coat coating in accordance with this invention. To improve adherence to a highly-polished, smooth metal surface, for example a Co—Cr surface (as in FIG. 1) or a Pd—Pt surface (as in FIG. 2), some modifications were made to the primer tie-coat adhesive layer. The object was thus to develop a solvent-soluble polymer, preferably using common, low toxicity and rapidly evaporating solvents, that could be applied by spray, by dipping, and by other acceptable coating methods, that would adhere securely to a highly polished, un-reactive, metal surface, that would also bond securely to the biocompatible copolymer-drug coat applied over the primer tie-coat layer in a subsequent operation, and that would resist the destructive actions of body fluids, be non-toxic inside the body, be reasonably inexpensive, be easily manufactured, and be storage-stable to a reasonable degree. It was especially desirable that the primer or tie-coat layer also have a rigorous resistance to the body's fluids and the body's attack on a foreign material, as well as being non-toxic and compatible both with the stent and with the biocompatible copolymer-drug coating.

In accordance with this invention, it was found that such a desirable primer coating or polymer tie-coat could be made by using substantially the same polycarbonate polyol(s) and diisocyanates (or polyisocyanates), in some embodiments with slight modifications, as those used for forming the biocompatible second copolymer layer. Desirable modifications of the pre-polymer components included modifications made for the purposes of increasing the inherent specific adhesion of the primer to the electropolished surface of a metal stent and improving the solubility of the tie-coat copolymer in a solvent such as toluene (although many solvents would also be useable). More specifically, a polyurethane-polyurea tic-coat copolymer was formed from the polyurethane prepolymer by chain-extending at least an isocyanate-terminated chain of the polymer with a diamine or a polyamine, for example with a specific mixture of aliphatic diamines, to make a high cohesive energy density copolymer that would have a range of viscosity in a readily evaporating solvent system, such as in toluene and alcohol. Other useful aromatic solvents/solvent systems were also identified, such as xylene, for example, and other non-polar solvents, such as tetrahydrofuran. Polar solvents such as methyl alcohol, ethyl alcohol, 1-propanol and 2-propanol, etc., can be used to extend the prepolymer with the diamine/polyamine or diamine/polyamine mixture.

It has also been found to be advantageous in some invention embodiments to use mixtures of a linear aliphatic diamine, such as ethylene diamine, and a non-linear diamine, such as 1,3-diaminocyclohexane, in forming the tic-coat copolymers of this invention. Such mixtures may usefully range from about 100% ethylene diamine/0% 1,3-diaminocyclohexane to about 100% 1,3-diaminocyclohexane/0% ethylene diamine. Numerous diamines, as known in this art, can be used to produce useful polyurethane-polyurea copolymers in accordance with this invention. One such commonly used diamine is isophorone diamine.

In a preferred embodiment, the diisocyanate is selected from the group consisting of methylene bis(4-cyclohexylisocyanate), isophorone diisocyanate, xylylene diisocyanate, TMXDI and hexamethylene diisocyanate; the polyol is selected from the group consisting of polycarbonate polyols having a MW of from 100 to 20,000, preferably from 500 to 6,000 as measured with hydroxyl numbers of about 225 to about 18; the diamine is selected from the group consisting of ethylene diamine, 1,2-propylene diamine, hydrazine, 1,4-diaminebutane, hexamethylene diamine, the diaminocyclohexanes, the phenylenediamines and such diamines as MOCA; and the solvent is selected from the group consisting of the following single solvents, and blends of any of the following: dimethyl formamide, dimethyl acetamide, tetrahydrofuran, dimethylsulfonamide, toluene, xylene, ethanol, methanol, 1-propanol, 2-propanol, butanols, hexanols, solvent naphthas, chlorinated solvents and the like.

### E. Examples

### Without the Use of a Tie-Coat Primer

The following laboratory prepolymers were prepared for test purposes.

In the following examples, PC-1122 and PC-1733 are polycarbonate polyols, supplied by Stahl USA. PC-1122 is a 2,000 MW polyol, and PC-1733 is a 1,000 MW polyol. The exact compositions are proprietary. DesmodurÂ® is a tradename for a line of polyisocyanates manufactured by Bayer MaterialScience. Desmodur® polyisocyanates are raw materials for the formulation of a variety of polyurethane coatings, adhesives and sealants. Desmodur products are available in both aromatic and aliphatic (light-stable) grades, and based on diphenylmethane diisocyanate (MDI), toluene diisocyanate (TDI), hexamethylene diisocyanate (HDI) and isophorone diisocyanate (IPDI) chemistry. Specifically Des W or Desmodur W is methylene bis(4-cyclohexylisocyanate). Because this is a cyclohexyl derivative, with two cyclohexyl rings per molecule, trans-trans, cis-trans and cis-cis isomers can exist. The ratio of these isomers is supposed to remain constant, and the product is (usually) stored in a large bulk storage tank when manufactured. T-9 is an organo-tin molecule, wherein the tin has a valency of 2 and the product is stannous octoate. This is a very reactive catalyst, and it hydrolyzes fairly rapidly in normal conditions and exposure. “NCO” refers to the isocyanate functional group. All isocyanate molecules have the isocyanate reactive group, most being di-functional in isocyanate. One can therefore measure the molecular weight of a urethane prepolymer, etc. by measuring the amount of available “—NCO” via titration. A preferred antioxidant is Vitamin E.

| | | | |
|---|---|---|---|
| Prepolymer #1: PC-1122 (56.8 OH) | 1 equivalent | 987.7 | gm |
| Desmodur W | 1.8 eq | 237.8 | gm |
| Anti-oxidant | | 2.5 | gm |
| | Total wt. | 1,228.0 | gm |
| NCO/OH = 1.8 | | | |
| Theoretical % NCO = 6.16 | | | |
| Prepolymer #2: PC-1122 (56.8 OH) | 1 eq | 987.7 | gm |
| Desmodur W | 1.8 eq | 237.8 | gm |
| Anti-oxidant | | 2.5 | gm |
| Toluene | | 526.3 | gm |
| | Total wt. | 1,754.3 | gm |
| NCO/OH = 1.8 | | | |

% solids = 70% Analysis: 70.14% solids.
Prepolymer viscosity = 15,100, LVF #4@ 6 rpm
Theoretical % NCO - 1.91

Note:
Prepolymer #2 above was still a viscous liquid six (6) months after manufacture as a lab batch.

Using prepolymer #2, several test samples were prepared for evaluation:

Test Sample 1: 0.10% T-12 (dibutyltin dilaurate) was added to Prepolymer #2, and the sample was evaluated as a moisture curing prepolymer.

Test Sample 2: 0.10% T-12+0.10% Bismuth carboxylate/2-ethylhexanoic acid were added to Prepolymer #2, and the sample was evaluated as a moisture curing prepolymer.

Test Samples 3a and 3b: 1,4-Butane diol was added to both Prepolymer #1 and #2, at the equivalents ratio of 0.98 and 0.985 NCO/OH, for evaluation as a thermoplastic urethane, both as a TPU and as a solvent solution of a TPU made in situ in solvent.

Test Samples 4-13: Prepolymer #2 was also prepared in each of the following solvents for evaluation as a TPU in situ solution:

4. Dimethylacetamide (DMAc)

5. Dimethyl formamide (DMF)

6. Dimethyl sulfoxide (DMSO)

7. Tert-butyl acetate

8. n-Butyl acetate

9. MBK

10. Methyl iso-butyl ketone

11. Tetrahydrofuran (THF)

12. Blends of THF and 1-propanol

13. Blends of THF and DMAc.

Each of these products was found to have its own positive and negative properties. The slow-evaporating solvents—for example, DMF (dimethyl formamide); DMAc (dimethylacetamide); DMSO (dimethyl sulfoxide); and blends containing an appreciable amount of these solvents—were slow to evaporate, which required either a short bake cycle at temperatures up to 120° C., or a lengthydry cycle at ambient conditions. However, the slow-evaporating solvents also proved to be the most powerful solvating solvents, and were excellent solvents for preparing the above formulations in solvent, or for dissolving the TPU resins according to this invention at levels ranging from about 0.01 to about 20 wt. % based on the solids content (i.e., the TPU content) of the solution. The fast-evaporating solvents were the best for applications, such as dipping or spraying stents or other articles, followed by a suitable drying cycle.

Test Samples 14: A series of both aliphatic and aromatic TPU resins according to this invention were evaluated for solubility in the solvents listed above, and in other solvents, including mixtures of THF, ethanol and water.

Test Samples 15: Solutions of TPU resins according to this invention in DMAc, in DMSO, in THF, in various mixtures of THF and DMAc and of THF and DMF, in THF and in 1-propanol were evaluated by dipping and spraying the test stents in or with the mixtures.

Based on experimental tests performed using the above-identified test samples, it was found that certain solvents and certain solvent mixtures coated best in dipping applications, while other solvent systems applied best in spray applications. However, none of these TPUs or in situ lab batches of TPUs (Test Samples 1-15 with no tie-coat layer) demonstrated the high level of excellent metal-surface adhesion that is desired and that is considered essential for a medical device coated with the applied drug-carrying polymer, nor were these samples suitable as a primer for subsequent biocompatible polymer coatings or layers. All of the coated and dried polymers applied to test stents using Test Samples 1-15 could be relatively easily scratched, abraded, or readily cut and peeled from the metallic surfaces of the stents.

### F. Examples

### With the Use of a Tie-Coat Primer

To evaluate the effectiveness of using a tie-coat primer in accordance with this invention, several commercial, as well as lab-made polyurethane resin water dispersions (not in accordance with this invention) were tested as primers in order to determine whether they imparted increased adhesion of an overcoated drug-carrying biocompatible polymer coating on the stents. Several of these polyurethane primers produced marginally acceptable but less than ideal evaluation results. For comparison, a special tie-coat polymer was prepared in accordance with this invention and especially designed for application as a primer on a highly electropolished metal surface of a medical device, such as on cardiac stents, and for use with the first-type polycarbonate-polyurethane biocompatible copolymers of this invention. A number of polyurethane, polyurea and polyurethane-polyurea copolymers were prepared for evaluation,

Tie-Coat Test Copolymers #1 and #2:

A polyurethane prepolymer #1 was made from a polycarbonate polyol and Desmodur W. Based on previous work, it was known that polyester-based polymers, even those based on excellent polyesters such as 1,6-hexane diol adipate and using either MDI or H₁₂MDI, and including excellent anti-oxidants, readily suffer hydrolysis, especially inside the human body. Further, it was also known that polyether-based polyurethanes, such as both PPG- and PTMEG based urethanes, suffer metal-ion oxidation which greatly shortens the polymer's useful life inside the human body.

Therefore, this experimental work focused on preparing polyurethanes, polyureas and polyurethane-polyureas using polycarbonate polyols, which have been found in accordance with this invention to have outstanding resistance to both hydrolysis and to metal-ion oxidation in the human body.

Thus, in this test, a polyurethane prepolymer was made as follows:

| | | | |
|---|---|---|---|
| PC-1122 (56.8 OH) | 1 equiv. | 987.7 | gm |
| Anti-oxidant | | 2.5 | gm |
| H₁₂MDI | 1.8 eq | 237.8 | gm |
| Toluene | | 526.3 | gm |
| T-9 | | 0.05 | gm |
| Total wt. | | 1,754.35 | gm |

This prepolymer was reacted at 90 to 100° C. for 2 hours, cooled to below 80° C., and the T-9 (Air Products stannous octoate) was added. A slight exotherm was observed indicating that the reaction had not been fully completed during the initial reaction period. The resulting polymer was found to comprise 1.87% NCO and 70.14% solids.

This polymer was then diluted with:

| | |
|---|---|
| Toluene | 1,319.3 gm |
| Iso-propyl alcohol | 1,845.6 gm |

The above polymer solution was then titrated with ethylene diamine to a viscosity of 52,500 cps (as measured by a Brookfield LVF Viscometer using a #4 spindle run @ 6 rpm) at 25° C. Analysis showed no residual isocyanate and a solids content of 25.84% solids. A second batch of the above polymer was made, but this time at an NCO/OH ratio of 2.0, and a chain extension was made with ethylene diamine. This time the viscosity was found to be 53,000 cps (LVF, #4@6 rpm) at 25° C. (#2). Chain extending the isocyanate-terminated polymer with a diamine (or comparable material that is at least difunctional in functionality) resulted in extending the length (and thus the molecular weight) of the polymer molecules. Extension of this lab batch gave a solids content of 25.73% solids. Solutions of this polyurethane-polyurea tie-coat copolymer were made at 1 wt. %, 2 wt. % and 5 wt. % solids in solvent mixtures of toluene and isopropanol at the same ratio of toluene and isopropanol, for dipping and spray application to the metal stents as a tie-coat primer. Adhesion of these tie-coats to the highly electropolished metal surfaces of the stents were satisfactory, but further improvement was desired.

Next, a series of seven CTI TPU solutions were made in solvents to be applied over the “primer” coated stents as described above. These test solutions can be identified as AL-80 A; AL-85 A; AL-93 A; AL-55 D; AL65 D; AL-72 D and AL-75 D, wherein the number designations refer to the durometer hardness of the cast CTI TPU.

In addition, the polymer as described above was also prepared in toluene and diluted with isopropanol, and was then chain extended using 1,2-propylene diamine. The results were found to be similar to the evaluation of the polymer as described above. The polymer solids were found to be 69.86% solids, with an NCO of 2.34% and a viscosity of 7,200 cps (before dilution with the isopropanol).

Both 1,2-PDA (1,2-propylene diamine) and DuPont Dytek EP diamine (a proprietary blend of 1,3-pentane diamine, 2,4-diethylhexahydropyrimidine and 4-ethyl-2-methyl hexahydropyrimidine) were used to chain-extend batches of the above polymer. The undiluted polymer was still a viable liquid after 5 months storage. Both the 1,2-PDA- and the Dytek-extended copolymer products showed favorable results in adhering to a highly electropolished metal surface of a stent.

Tie-Coat Test Polymers #3 and #4:

A prepolymer was made from the following components:

| | | | |
|---|---|---|---|
| PC-1122 (58.6 OH) | 1 equiv. | 987.7 | gm |
| Anti-oxidant | | 2.5 | gm |
| toluene (to 60 wt %) | 2 equiv. | 537.6 | gm |
| Desmodur W | | 264.2 | gm |

The components were mixed and cooked as usual (90° to 100° C. for 2 hours, cooled to below 80° C.), and 2 drops of T-9 catalyst were then added. When any exotherm was completed, the prepolymer was cooled and poured off into a closed plastic container under a nitrogen atmosphere. The resulting polymer was found to have a viscosity of 7,200 cps (LVF, #3@12 rpm) at 25° C. with a solids content of 69.86%. The % NCO was found to be 2.34%.

This polymer was chain-extended with EDA and also with 1,2-PDA. Both diamines gave excellent diamine extensions of the diluted polymer. The polymer was then further extended and diluted as follows:

| | |
|---|---|
| polymer | 100 gm |
| toluene | 55 gm |
| isopropanol | 95 gm |
| | 250 gm |

Further preparation steps included the following:

(a) 55 drops of ethylene diamine were added, dropwise, with good agitation to a first aliquot of the polymer. After every 10 drops added, the mix was stirred for 5 minutes, and a viscosity test was performed. Near the end point of the addition, the viscosity was taken more frequently. Final viscosity was 48,350 cps (25° C.) at 25.64% solids (#3),

(b) A similar aliquot of the polymer was chain-extended using duPont Dytek EP diamine. 87 drops of Dytek EP were added dropwise, as above, to a final end point. The final viscosity was found to be 51,740 cps at 25.86% solids (#4).

These extended solutions (#3 and #4) were reduced in solids with a similar toluene/IPA mix ratio to 1% solids and to ½% solids for spraying onto stents, using the Sono-Tek spray apparatus. The “primer” sprayed stents were thoroughly dried and then overcoated in the same manner, by applying a ½% solids CF AL 93 A solution ion THF using the Sono-Tek spray apparatus. (CF AL 93 A is a specific Chronoflex polycarbonate-polyurethane 93 A durometer TPU, which has been granulated and pelletized. The solution is made by adding 0.5 gram of the CF AL 93 A TPU to 99.5 grams of tetrahydrofuran, and heating and agitating the mixture to made a % solids solution of the TPU.)

Test panels were made by making 2½% solids solutions of #12-2, and 3½% solids solutions were made using #17-2 and also #17-3. Test polymer 412-1, as previously described, is an ethylene diamine extended polymer [PC-1122, Des W, and antioxidant made in toluene at 70% solids content (70.12% analysis) at 1.91% NCO, having a viscosity of 15,100 cps, Brookfield LVF Viscometer, using a #4 spindle at 6 rpm, 25.84% solids content]. Test polymer #17-2 is an ethylene diamine extended polymer [PC-1122, Des W, and antioxidant, made in toluene at 70% solids (69.86% analysis), having a Brookfield LVF Viscometer viscosity of 7,200 cps using a #3 spindle at 12 rpm, 25.64% solids content]. Test polymer #17-3 is a Dytek EP diamine extended polymer [same polymer as #17-2 polymer, above] to give an extended polymer having a Brookfield LVF Viscometer viscosity of 51,740 cps at 25.86% solids content. Separately, test solutions were made from a commercially available polyurethane dispersion (PUD) (this was Bayer B-124). This commercially available PUD was found, in extensive previous tests, to be the best commercially available PUD. This PUD was diluted to 1%, 2½% and 5% solids for testing. 1×7 inch test strips of stainless steel were dipped into each solution, slowly withdrawn (as per commonly used technique familiar to those involved in this art), and hung to air dry. Separate metal coupon samples were also made as above and hung to dry in an oven maintained at 75° to 80° C. for 1½ hours. The dried test panels were scratched with thumbnails, a coin, the end of a paperclip, and the point of a stainless steel scalpel. All of these tests demonstrated good adhesion of the coating to the metal surface.

Tie-Coat Test Polymers #5 and #6: Another prepolymer was made by adding 0.25 equivalents (i.e., one-quarter of the equivalent weight of the material, measured here in grams) of dimethylolpropionic acid (DMPA) to 1 equivalent of PC-1733. The DMPA was added to increase the adhesion of the primer to the stent. The use of DMPA together with PC 1733 is considered novel, especially for the purpose of application to a cardiac stent and in similar applications as may be determined.

The starting prepolymer was made from the following components:

| | | | weight % |
|---|---|---|---|
| PC-1733 (128.6 OH) | 436.2 | gm | 39.12 |
| DMPA | 16.8 | gm | 1.51 |
| Anti-oxidant | 2.0 | gm | 0.18 |
| Chronoflex AL93 A | 19.0 | gm | 1.70 |
| Toluene | 334.5 | gm | 29.98 |
| Des W | 306.5 | gm | 27.505 |
| T-9 catalyst | 0.05 | gm | .005 |
| | 1,115.05 | gm | 100.000 |

The resulting polymer was dissolved in toluol and isopropanol at 25% total solids content, and chain-extended with EDA to a viscosity of about 4,000 cps at 25° C. (#5). A second sample was also extended with FDA to a viscosity of 25,250 cps@ 25° C. (#6). These two primer coatings (#5 and #6) were spray applied to metallic stents, dried and then evaluated for scratch resistance and adhesion. The dried coatings of the above polyurethane-polyurea products, as applied to metal stents, demonstrated excellent adhesion as well as excellent tear and scratch resistance. Additional applications of these materials to stents was done by dipping the stents into 5%, 2%, 1% and/2% solids solutions of the respective extended products in toluol and isopropanol. In addition, the diluted primer coatings (as above) were applied to stainless steel coupons, dried, and again found to have excellent adhesion and tear resistance. In addition, films of the 25% solids extended products were cast on a glass plate, using about 20 mils of masking tape as border constraints and drawing down the extended products (#5 and #6) with a glass rod. The dried film was removed from the glass plate and found to have excellent elongation as well as very good tensile strength.

The above polymers (#5 and #6) were still viable, viscous liquids after four months storage. After several days of drying, the tensile strength of the cast films of the above chain-extended products were found to have excellent tensile strength.

Tie-Coat Test Polymers #7 and #8:

The starting polymer was made from the following components:

| | | |
|---|---|---|
| PC-1122 (56.8 OH) | 987.7 | gm |
| Anti-oxidant | 3.0 | gm |
| DMPA | 16.8 | gm |
| toluol (to 70% solids) | 368.2 | gm |
| Des W | 314.4 | gm |
| T-9 catalyst | 0.05 | gm |
| | 1,888.45 | gm |
| | 1,321.95 | solids; 70% solids |

The resulting polymer was extended with toluol and ethanol as follows:

| | | |
|---|---|---|
| polymer | 400 | gm |
| toluol | 320 | gm |
| ethanol | 280 | gm |
| | 1,000 | gm at 28% solids. |

This solution was then chain-extended with EDA and immediately diluted to about 11.5% solids. Two test samples (#7 and #8) were made identically, but varied slightly in solids content. Sample #7 had a final solids content of 11.91% NV and sample #8 had a solids content of 11.72% NV. These two samples retained their viscosity for approximately five months, and are in test use frequently, being applied as a primer on metallic stents, as well as a primer coating on Pellethane and Pebax tubing, catheters and balloon catheters.

This application, accordingly, generally discloses and is intended to cover special classes of biocompatible/biodurable copolymers, related classes of tie-coat copolymers, paired combinations of the biocompatible/biodurable copolymers with the tie-coat copolymers, methods of preparing such copolymers, articles (especially medical devices) coated with one or a combination of such copolymers, and methods of applying such copolymers to form the coated articles. The drawings and examples included herein are intended for illustrative purposes only and should not be construed as in any way limiting the scope of the invention or this application.

It will be understood that many variations and changes in the chemical compositions and selection of the polymer components, the procedures used for forming the polymers of this invention, various process parameters, solvents and proportions selected, coating application techniques, and other described features of this invention can be made by routine experimentation to optimize one or another performance aspect of the completed products without departing from the spirit or scope of this application.

1. A first-type polycarbonate-polyurethane copolymer formed by the reaction of one or more polycarbonate polyols with one or more polyisocyanates.

2. A first-type polycarbonate-polyurethane copolymer according to claim 1 wherein the polycarbonate polyol is a polycarbonate diol formed by the reaction of an aliphatic diol with a dialkyl carbonate.

3. A first-type polycarbonate-polyurethane copolymer according to claim 1 wherein the polyisocyanate is selected from the group consisting of aliphatic and aromatic diisocyanates and polyisocyanates.

4. A first-type polycarbonate-polyurethane copolymer according to claim 2 wherein the polyisocyanate is selected from the group consisting of aliphatic and aromatic diisocyanates and polyisocyanates.

5. A first-type polycarbonate-polyurethane copolymer according to claim 1 wherein the polyisocyanate is selected from the group consisting of toluene diisocyanate (TDI); methylene bis-phenylisocyanate (diphenylmethane diisocyanate) (MDI); hexamethylene diisocyanate (HDI); naphthalene diisocyanate (NDI); methylene bis-cyclohexylisocyanate (hydrogenated MDI or HMDI); isophorone diisocyanate (IPDI); and tetramethylxylylene diisocyanate (TMXDI).

6. A first-type polycarbonate-polyurethane copolymer according to claim 1 prepared by the sequential steps of:
(a) premelting the starting solid polycarbonate;
(b) charging one or a mix of polyols into a reactor;
(c) optionally adding other ingredients selected from the group consisting of: anti-oxidants; waxes for aid in molding, pellerizing, and extruding; phosphites as color stabilizers; modifying polyols; air-release additives; dyes; Cabosils or other platy or more spherical solids; and metal salts;
(d) melting the polyol mix at a temperature of about 20° C. to about 100° C.;
(e) degassing the polyol mix under partial vacuum conditions of about 25 to 29 inches of mercury while it is being agitated thereby removing trapped gasses and moisture;
(f) breaking the vacuum by adding nitrogen gas;
(g) adding the polyisocyanate(s) and a polymerization catalyst to the polyol mix and mixing the ingredients to form a substantially homogeneous polymerization mixture, wherein the polymerization catalyst is selected from the group consisting of: amines; organo-metallic catalysts; bismuth salts; and titanium salts;
(h) establishing and maintaining a polymerization reaction temperature for a sufficient period of time for the polymerization mixture to teach a desired molecular weight; and,
(i) degassing the reacted polymerization mixture to remove dissolved gasses.

7. A first-type polycarbonate-polyurethane copolymer prepared according to the steps of claim 6 wherein the starting polycarbonate has a molecular weight ranging from about 1000 to about 2000.

8. A first-type polycarbonate-polyurethane copolymer prepared according to the steps of claim 6 and additionally the step of adding an extender to the reacted polymerization mixture to form a thermoplastic polyurethane polymer mix having particular physical and/or chemical properties.

9. A first-type polycarbonate-polyurethane copolymer prepared according to the steps of claim 8 wherein the extender is selected from the group consisting of 1,4-butane diol and 1,6 hexane diol.

10. A first-type polycarbonate-polyurethane copolymer product comprising a predominant proportion of a first-type polycarbonate-polyurethane copolymer according to claim 1 mixed with an effective amount, effective to impart desired physical, chemical and/or medical properties to the copolymer product, of one or more additives selected from the group consisting of drugs, antioxidants, anti-inflammatory agents, stabilizers, UV absorbers, colorants, pigments and dyes.

11. A first-type polycarbonate-polyurethane copolymer product comprising a first-type polycarbonate-polyurethane copolymer according to claim 1 dissolved in a suitable solvent.

12. A first-type polycarbonate-polyurethane copolymer product according to claim 11 wherein the solvent is selected from the group consisting of dimethylformamide, dimethylacetamide, tetrahydrofuran, dimethylsulfoxide, acetates, ketones, and combinations thereof.

13. A polycarbonate-polyurethane copolymer according to claim 1 wherein at least an isocyanate-terminated chain of the first-type polycarbonate-polyurethane copolymer has been chain-extended by reaction with a diamine, a polyamine, or mixtures thereof to form a second-type polycarbonate-polyurethane copolymer.

14. A polycarbonate-polyurethane copolymer of a according to claim 1 wherein at least an isocyanate-terminated chain of the first-type polycarbonate-polyurethane copolymer has been chain-extended by reaction with a diamine, a polyamine, or mixtures thereof to form a second-type polycarbonate-polyurethane copolymer, wherein the chain-extension reaction is with a diamine selected from the group consisting of ethylene-diamine, 1,2 propylene diamine, 1,3 diaminocyclohexane, isophoronediamine and mixtures thereof, or with a polyamine selected from the group consisting of cyclohexylamines, benzyl amines, naphthyl amines, methylenebis (4-phenylamine), TMXD amines and mixtures thereof.

15. A second-type polycarbonate-polyurethane copolymer formed by chain-extending a first-type polycarbonate-polyurethane copolymer according to claim 1 by reacting at least an isocyanate-terminated chain of the first-type polycarbonate-polyurethane copolymer with a diamine, polyamine or mixture thereof.

16. A second-type polycarbonate-polyurethane copolymer product wherein a first-type polycarbonate-polyurethane copolymer according to claim 1 is formed by the reaction of one or more polycarbonate polyols with one or more polyisocyanates, the first-type polycarbonate-polyurethane copolymer is chain extended by reacting at least an isocyanate-terminated chain of the first-type polycarbonate-polyurethane copolymer with a diamine, polyamine or mixture thereof to form a second-type polycarbonate-polyurethane copolymer, and the second-type polycarbonate-polyurethane copolymer is dissolved in a suitable solvent.

17. A second-type polycarbonate-polyurethane copolymer according to claim 16 wherein the solvent is selected from the group consisting of aromatic solvents, polar solvents and mixtures thereof.

18. (canceled)

19. An article having an article surface, wherein at least a portion of the article surface is coated with a first-type polycarbonate-polyurethane copolymer or a first-type polycarbonate-polyurethane copolymer product, wherein the first-type polycarbonate-polyurethane copolymer is formed by the reaction of one or more polycarbonate polyols with one or more polyisocyanates.

20-22. (canceled)

23. An article according to claim 19 wherein the article surface is a metal surface.

24. An article according to claim 19 wherein the article surface comprises a metal is a selected from the group consisting of cobalt-chromium alloy and platinum.

25-34. (canceled)
